(19) United States
(12) Patent Application Publication
(10) Pub. No.: US 2003/0146914 A1
(43) Pub. Date: Aug. 7, 2003

(54) Representation of three-dimensional bodies on computer screens and games involving such representations

(76) Inventor: Mordehai Sholev, Menashe (IL)

Correspondence Address: Howard and Howard Attorneys, P.C., 39400 Woodward, Ste. 101, Bloomfield Hills, MI, 48304, US

(21) Appl. No.: 10/301,892

(22) Filed: Nov. 22, 2002

Related U.S. Application Data
(63) Continuation of application No. PCT/IL01/00479, filed on May 24, 2001.

(30) Foreign Application Priority Data
May 25, 2000 (IL) 136373

(51) Int. Cl. G06T 15/00

(52) U.S. Cl. 345/419

(57) ABSTRACT

Process for generating the image of a 3-dimensional rigid body on a computer screen. a system of 3-dimensional space coordinates is defined in the space in which the body moves. Software, which defines the way in which the body appears when viewed at a given angle and distance to one of the coordinate planes is established and the coordinates are determined in the coordinates system of a number of points. The coordinates of the points of the rigid body and the software are transmitted to the computer, which creates the image of the rigid body when in any specific position in space and viewed at any specific angle. The points of the rigid body, the coordinates of which are determined, may be in the number of three. The rigid body may have symmetries and the points thereof, the coordinates of which are determined, may be less than three.

This application is a continuation application of International application PCT/IL01/00479 filed on May 24, 2001.

### FIELD OF THE INVENTION

This invention relates to the representation of 3-dimensional bodies on computer screens, to the manipulation of such representations, to the manipulation of virtual bodies defined on computer screens, and to computer games involving such manipulations by players who can be located at different locations.

### BACKGROUND OF THE INVENTION

For the sake of clarity and of brevity, a list of terms and their abbreviations is given hereunder:

software=“SW”

graphic software=“GSW”

representation of a real body on the computer screen=“image”

representations on the computer screen of bodies which have no physical existence and are created by computer files=“virtual bodies”

persons who manipulate real bodies and/or their images and/or virtual bodies to carry out any activities involving such manipulation, e.g. games or 3D designing software=“players”.

It is known in the software art to create computer files which generate virtual bodies on the computer screen and permit to manipulate such virtual bodies in any desired way. Producing virtual bodies and manipulating them, therefore, is not a part of this invention, although it may, be part of carrying the invention into practice.

A way of creating and manipulating images of real, 3-dimensional bodies, however, is provided by this invention and is an aspect of it.

Persons skilled in the art, further, are able to provide software to control the interaction between virtual bodies and/or images of real bodies as they are manipulated or moved and changed, according to other software, on the computer screen.

It is a purpose of this invention to provide a method for representing real, 3-dimensional bodies, by images on a computer screen.

It is another purpose of this invention to control images on a computer screen by manipulating real bodies, or parts thereof.

It is a further purpose of the invention to provide means whereby players may play computer games by manipulating real or virtual bodies and controlling their behavior on a computer screen.

It is a still further purpose of this invention to permit players, while located at entirely different locations, even at great distances from one another, to play together computer games involving the manipulation of real or virtual bodies.

It is a still further purpose of this invention to permit to manipulate virtual images and change their configuration by manual means.

Other purposes and advantages of the invention will appear as the description proceeds.

### SUMMARY OF THE INVENTION

General Considerations

Several aspects of the invention and phenomena related to it will now be briefly described, for the sake of clarity.

The simplest problem which the invention solves is the creation of an image of a single rigid body on a computer screen. A rigid body can be defined by SW, with reference to a plane, which will be called the “body reference plane” (hereinafter, briefly, BRP) to distinguish it from other reference planes. Three points locate the plane in space: an SW, which persons skilled in the art can provide, defines the structure of the rigid body with respect to the body reference plane. It will be understood, and this consideration should be implicit in any later reference to SW, that the definition of any body by means of software of any kind may be an imperfect one, since a perfect definition would require, in general, very large digital files, and it may, in some cases, be desirable, or even necessary, to compress the files by compression methods well known to persons skilled in the art Now, the image of a rigid body will change according to the angle under which the body is seen; therefore, it will change as the body reference plane rotates with respect to another reference plane associated with a computer screen, and which will be called the “computer reference plane” (hereinafter, briefly, CRP); or it will change its distance from said plane. The image will also change if the body reference plane merely translates parallel to the computer reference plane. The way in which the image of a rigid body changes as its reference plane rotates, or changes its distance from the computer reference plane, is defined by SW which persons skilled in the art can provide.

It may be necessary to create images of composite rigid bodies, viz. bodies that consist of several components, each of which is a rigid body and which are pivoted to one another. In this case, if one of the said rigid bodies is considered as the base one, the location of which in space is determined by “n” points, less than “n” points will be required to determine the location of the components. Thus, if a pivot has two degrees of liberty, it decreases the points required from “n” to “n−1”. If it has a single degree of liberty, it decreases them from “n” to “n−2”.

The image of a deformable body is created basically in the same way as that of a rigid body, except that the SW that defines the body must determine how the deformations thereof are transferred to the image.

In the said SW is generally included a data base containing information on the properties of the images. Such properties are essentially of two kinds. The first kind includes animations that occur as a result of the condition or motion of a given body. As an example, one can consider the body of a plane that moves with a certain speed and the computer screen shows the image of a flying plane and shows fire is issuing from the motors of the image on the screen. The second kind of properties concern the relationship of a body to other bodies. Animations result from the generation or transformations of a given array of real bodies, the images of which are displayed on the computer screen.

Playing games, or computer operations less simple than the mere representation of a body, may require, in the simplest case, to take into account the interaction between rigid bodies. Single rigid bodies may be considered for the sake of simplicity, as the same considerations are valid for components of composite rigid bodies. The said interaction requires that the BRP of a rigid body A be shifted, by translation and/or rotation, depending on the position and/or orientation of the BRP of another rigid body B.

Before bodies may interact, an SW may be provided to establish how the displacements (by translation or rotation) of the BRP of a rigid body A affect the images of another rigid body B. This could be called “limited interaction”. “Complete interaction” occurs when the SW establishes how the aforesaid displacements and the deformation of a body A affect the position and orientation of the BRP and cause deformation of another body B. In computer games, the interaction is not necessarily limited to the visual aspect of the bodies on the screen, but may include acoustic aspects and animation of the virtual surroundings in which the bodies are situated.

So far, interaction between real bodies has been considered. However, real bodies can interact with virtual bodies or virtual bodies may interact with images of real bodies. Essentially, in those cases, the SW is of the same kind as that governing complete interaction between deformable bodies. Likewise, interaction may occur between virtual bodies only.

For controlling the interaction, it may be desirable or necessary to associate points between real and virtual bodies, between virtual and virtual bodies or between virtual bodies and images, as will be better explained hereinafter.

Process of the Invention

According to an aspect of the invention, the image of a 3-dimensional rigid body is generated on the computer screen by:

One) defining a system of 3-dimensional space coordinates (viz. an origin O and the orientation of three coordinate planes) in the space in which the body moves;

b) establishing a SW(α,distance), which defines the way in which the body appears when viewed at an angle α to one of the coordinate planes and at a given distance from the origin of the coordinates or from the computer reference plane;

c) determining the coordinates of three (or less, in case of symmetries or kinematic bonds) points of the rigid body in said coordinates system; and

d) transmitting to the computer said coordinates of said points of the rigid body and said SW((α,distance); whereby the computer will create the image of the rigid body when in any specific position in space and viewed at any specific angle α and at any specific distance from the computer reference plane.

With reference to the SW(α,distance), it should be noted that said SW refers not only to the value of the angle, but also to its derivatives that express the speed and the acceleration of its change, and refers not only to the value of the distance, but also to its derivatives that express the speed and the acceleration of its change. The said derivatives are vectorial quantities that permit to calculate and/or foresee the direction in which the body will move and the forces that are required to maintain or to change its motion.

Various methods are known in the art for determining the position of points. U.S. Pat. No. 5,012,049 to Schier describes a position determining apparatus having embodiments providing two-dimensional and three-dimensional position information. The apparatus comprises a pen-sized movable transmitting device and a plurality of receivers, where the transmission is of pulses of laser light. For determining three-dimensional (3-D) position, the apparatus has two transmitters and four receivers, three of which are coplanar and the fourth is in a non-coplanar relationship with the other three.

Position determining apparatus are also utilized as position measuring devices. U.S. Pat. No. 3,924,450 to Uchiyama et al describes a device for measuring coordinates of models. It comprises a supersonic transmitter located somewhere on the model and three supersonic receivers located in space. The transmitted signal, when analyzed, provides the location of the transmitter on the model.

Pending PCT application PCT IL99/00301, the contents of which are incorporated herein by reference, discloses a method for determining spatial and/or planar position of a point comprising positioning two or more transmitters substantially along a straight line passing through the point, the position of which it is desired to determine, and calculating said position using the position of said two or more transmitters, the distance between them and the distance between said point and one of the transmitters.

A typical method for determining the location of points, to which reference will be made hereinafter for the sake of example although other methods can be adopted, comprises providing a transmitter or emitter (the terms “emitter” and “transmitter” are used herein as synonyms) of radiation of any kind (e.g. optical, as laser light or infrared, acoustic, RF, or other) at the point to be located, providing three receivers of said radiation at three known and fixed positions; and determining the distance between said point and each of said receivers from the time required for the emitted radiation to reach said receivers, whereby the position of the point can be determined with respect to the receivers. The positions of the receivers is known, viz. their coordinates with respect to a coordinate system is known. Actually, it is the coordinates assigned to the receivers that define the coordinate system. For instance, a first receiver may be taken as the origin of the coordinates, the line passing through said receiver and a second one can be taken as one coordinate axis, and the plane defined by said line and the third receiver can be taken as one coordinate plane. However, the coordinate system may be defined in any desired way. It should be understood that, whenever reference is made in this specification and claims to the position or the coordinates of an emitter or a receiver, said position or coordinates are those of the corresponding emitting or receiving antenna. Thus, it is possible and will often occur that a single radiation generator or radiation collector will be connected to a plurality of antennae (in this invention, generally three), and in this case, each antenna will be considered herein as a separate radiation emitter and its position, and not that of the radiation generator or collector, will be relevant. This observation should be considered implicit in any reference to emitter or receiver position or coordinates, though it will not be repeated.

If the aforesaid way of locating points, by the steps listed hereinbefore, is adopted, step a) of the aforesaid aspect of the invention includes providing a required number, typically three but optionally more, of radiation receivers, and attributing to them three coordinates X,Y,Z; and step c) includes providing a radiation emitter at each of the three points of the rigid body, determining in a known way the distance of each of said points from each of said receivers, and calculating from said distances the coordinates of each of said points in the coordinate system established in step a). It will be understood that the location of an emitter is that of the antenna from which the radiation is emitted and that said radiation may be generated elsewhere, and that a single radiation generator may feed a plurality of antennae, viz. a plurality of emitters. If the aforesaid way of locating points is adopted, persons skilled in the art will know what changes will occur in the details of steps a) and c). The coordinates system is preferably, but not necessarily, Cartesian, viz. the coordinate planes are preferably mutually perpendicular and it will be convenient that one of the coordinate planes be parallel to the CRP.

A further step e) may be desirably added to the aforesaid steps a) to d), which step e) is the evaluation of the error involved in measuring the coordinates of the radiation emitters. Said error can be calculated from the known distances between the emitters, compared to the distances calculated each time from the measured distances of the emitters from the receivers.

In particular cases, three points may not be necessary because of symmetries possessed by the rigid body. In the most extreme case, that of a sphere, it is sufficient to determine the position of the center of the sphere. If the body has an axis of symmetry, it will be sufficient to determine the position of the axis, which requires the coordinates of only two points.

Another simplification is provided by possible connections between the rigid bodies. As stated hereinbefore, two component rigid bodies may be connected by a kinematic connection, e.g. a pivot. Once the image of one of them, taken as base components, is determined, that of another component connected to it will be a function of the parameters of the kinematic connection, e.g., if the connection is a pivot, a function of one or two angles with respect to the basic component, depending on the degrees of liberty of the pivot. For instance, the human body may be schematically represented by a number of rigid parts connected by pivots having one degree of liberty (such as elbows and knees) or two degrees of liberty (such as the articulation of the upper arm to the shoulder).

According to the invention, images of deformable bodies are created in the same way as that of rigid bodies, except that a SW will be formulated, as can be done by persons skilled in the software art, to direct how the deformations are translated into changes of the image.

According to another aspect of the invention, a process is provided for representing the interaction between two real bodies, which comprises:

1st) generating an image of a first real body, as described hereinbefore;

2nd) generating an image of a second real body, as described hereinbefore;

3rd) modifying or integrating the SW(α,distance) relative to said first body to cause the image thereof to react to the presence within a certain distance, and, optionally, in a certain direction, of the image of said second body.

The above aspect of the invention can be expanded, if said second real body is deformable, by modifying or integrating said SWS (60 ,distance) to cause said first real body to react not only to the presence of the image of said second body, but also to its deformations.

According to a further aspect of the invention, a process is provided for representing the interaction between a real body and a virtual body, which comprises:

4th) determining a GSW which creates a virtual body;

5th) generating an image of a real body, as described hereinbefore;

6th) modifying or integrating said GSW to cause said virtual body to react to the presence of said image within a certain distance, and, optionally, in a certain direction and orientation.

If a real body is known in advance, the GSW may he formulated from the beginning to include step C. Otherwise, step C is carried out as soon as the real body is identified.

The above aspect of the invention can be expanded, if the real body is deformable, by modifying or integrating said GSW to cause the virtual body to react not only to the presence of the image of the real body, but also to its deformations.

According to a still further aspect of the invention, a process is provided for representing the interaction between real points, defined in space, and a virtual body or an image, which comprises:

I) defining a set of 3-dimensional space coordinates in the space in which the body moves, and storing in the computer's memory the definition of said set;

B) associating said real points to points of the virtual body or the image;

III) modifying the SW or GSW, which controls the virtual body or the image, insofar as necessary, to react to the motion of said real points;

IV) determining the coordinates of said real points with respect to said space coordinates set; and

V) transmitting to the computer said coordinates of said real points.

The real points may be part of a single or composite real body, but, typically, they will be disjointed points, displaced independently of one another, e.g. radiation emitters carried by the fingers of an operator's hand, in which case the virtual body or image may be actuated much as a puppet can be actuated by pulling strings or by an articulated control device.

A still further aspect of the invention is a process for producing and controlling the deformation of virtual bodies or images, which comprises providing a deformable control body having at least two sets of radiation transmitters or emitters, defining two systems of spatial coordinates by the positions of said emitters, associating each of said coordinate systems to one of two parts of the virtual body or image and deforming said control body to change the distance and/or relative orientation of said coordinate systems, whereby to change the distance and/or relative orientation of said two parts of the virtual body or image. Each set of radiation emitters preferably comprises a radiation generator and at least three emitter antennae connected to said generator.

The aforesaid control body is a new article of manufacture and as such is a part of this invention.

### BRIEF DESCRIPTION OF THE DRAWINGS

In the drawings:

FIG. 1 is a schematic plan view of a rigid body, the image of which is to be created;

FIG. 2 is a cross-section of said body taken on its BRP;

FIG. 3 is a cross-section of said body taken perpendicularly to its BRP;

FIG. 4 is schematic perspective view illustrating the definition of a coordinate system;

FIGS. 5 to 7 are schematic illustrations of bodies having symmetries;

FIG. 8 is a schematic illustration of a composite body;

FIG. 9 is a schematic illustration of an arm of a composite body;

FIGS. 10 to 12 schematically illustrate the manipulation of a virtual body;

FIG. 13 schematically illustrates the manipulation of a virtual human head;

FIG. 14 schematically illustrates a control body for controlling deformations of virtual bodies or images;

FIG. 15 is a schematic illustration of a control body;

FIGS. 16A and 16B schematically illustrate the structure of the electronic circuits contained in a control body;

FIGS. 17A and 17B schematically illustrate the use of a player's forearm and hand as control body;

FIGS. 18A and 18B schematically illustrate such a use effected by twisting motions;

FIGS. 19A and 19B schematically illustrate the stretching of a virtual head produced by stretching a control body;

FIGS. 20A and 20B schematically illustrate the deformation by compression of a virtual head 92 produced by compressing a control body; and

FIGS. 21A to 21E schematically illustrate the manipulation of a virtual composed body using a control body.

### DETAILED DESCRIPTION OF PREFERRED EMBODIMENTS

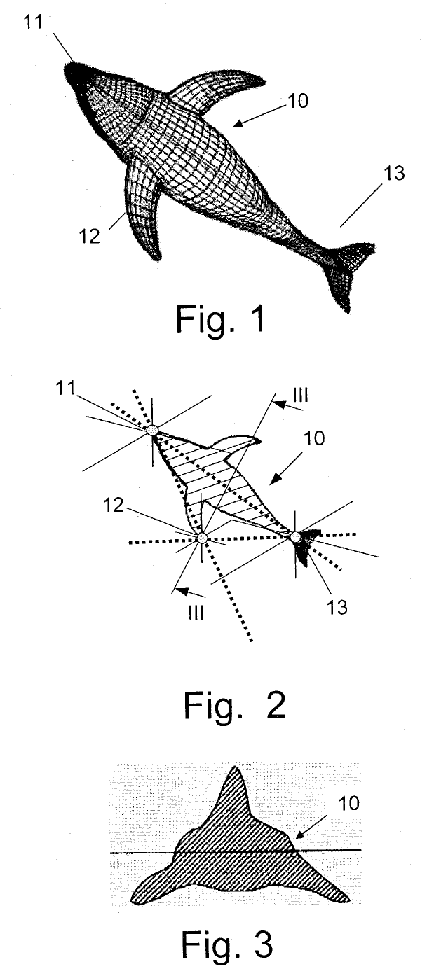

FIGS. 1 to 3 illustrate an example of representation of a rigid body on a computer screen, said body being shown as a stylized fish 10 by way of example. In FIG. 1, fish 10 is shown in plan view. Three points are chosen for representing it on the computer screen, and while the choice is arbitrary, they are indicated as points 11, 12 and 13 located at or near the periphery of the fish body. FIG. 2 is a cross-section of fish body 10, taken on the plane which is defined by points 11, 12 and 13, which is the BRP of the body and which is indicated as plane X-Y. FIG. 3 is a transverse cross-section of fish body 10, taken on plane III-III of FIG. 2, perpendicular to the BRP.

A digital file defining said fish body with respect to plane X-Y is assumed to be available. Actually, such file need only attribute a coordinate z to each point of said fish body having coordinates x-y. in plane X-Y. Radiation emitters, which in this case will be assumed to be RF emitters, are mounted on each of points 11, 12 and 13. Once the position of said points is determined, they can be indicated on the computer screen, so that the BRP of body 10 becomes identical to CRP, and the digital file representing the fish body 10 will determine the image seen on said screen, depending on the angle of plane X-Y with respect to the CRP.

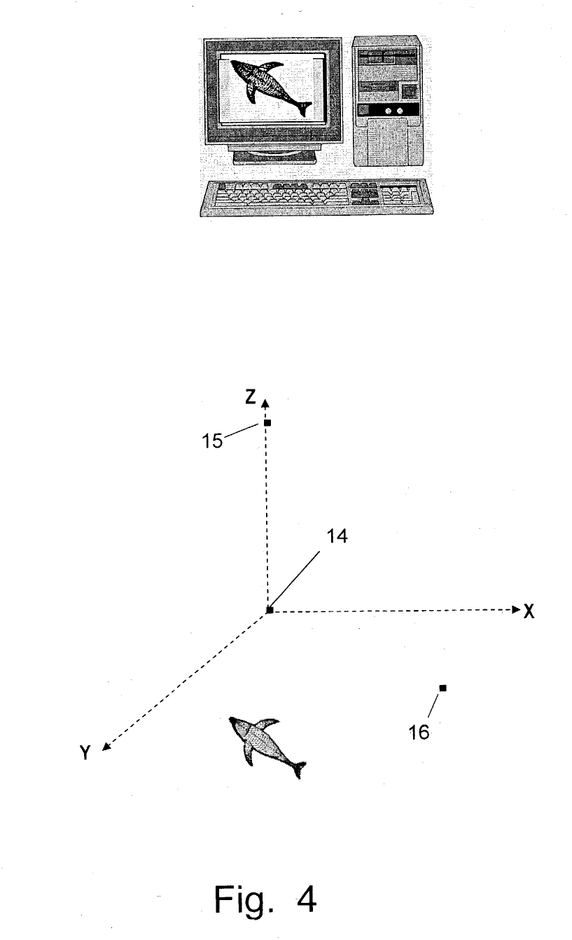

FIG. 4 illustrates schematically in perspective view the process, known in itself, of determining the location of points 11, 12 and 13. Three receivers 14, 15 and 16 are placed in fixed position in the space in which the fish body is located and displaced. Receiver 14 is taken as the origin of the coordinate system, the line between receivers 14 and 15 is taken as the Z axis, coordinates x and y are attributed to receiver 16 and a z coordinate to receiver 15. A system of coordinate axes X, Y and Z is thus defined. While the person or player who operates the fish body 10 does not directly refer to the coordinate axes or the coordinates of the various points, these are implicit in the software used to create and manipulate the image of the fish body.

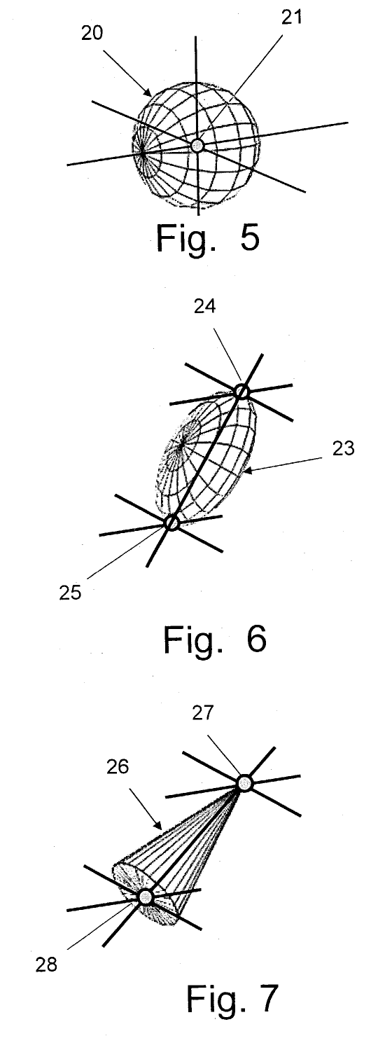

FIGS. 5, 6 and 7 illustrate simplified kinds of rigid body representation process. FIG. 5 illustrates a sphere 20 having a center 21. Obviously, the digital file representing the sphere contour with reference to its center is a very simple one. To create an image

of the sphere it is sufficient to represent on the computer screen the position of the center 21. Any plane passing through said center can be taken as the BRP.

FIGS. 6 and 7 represent two bodies that are symmetric with respect to an axis. Any plane passing through said axis can be taken as the BRP. The body 23 of FIG. 6 is generated by the rotation of an arc of circle lying on the BRP and passing through points 24 and 25, as the BRP rotates about the axis of symmetry defined by said points. Once said points are represented on the computer screen, the software defining the contour of body 23 will create the body image. The body 26 of FIG. 7 is a cone and is symmetric about an axis passing through the vertex 27 of the cone and the center 28 of its base. Any plane passing through said axis can be taken as the BRP. The image of body 26 is created in the same way as that of body 23.

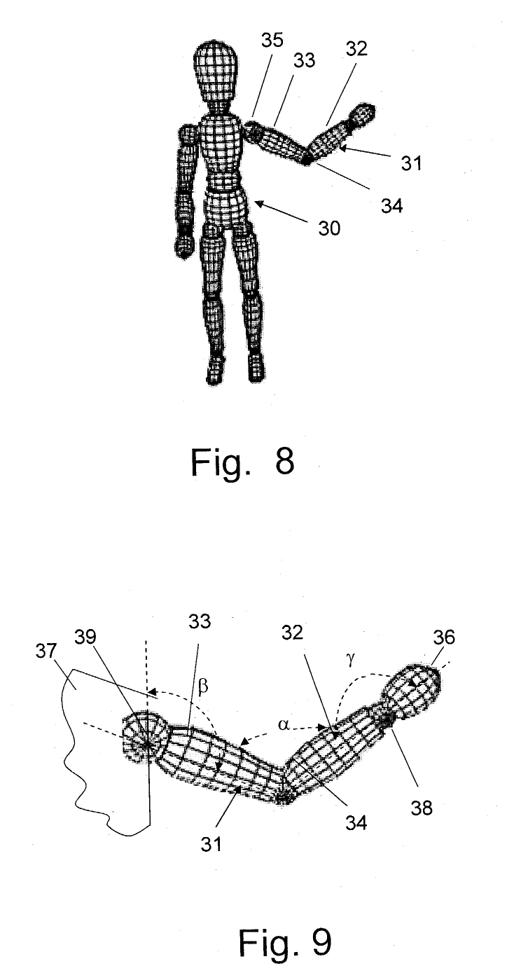

FIG. 8 is a schematic illustration of a simplified puppet 30 representing a human body. It is seen that said puppet is comprised of a number of component rigid bodies joined by pivots having one or two degrees of liberty, and representing joints of the human body. If one considers, by way of the example, an arm generally indicated at 31, it is composed of a forearm 32 and an upper arm 33 joined by pivot 34, while upper arm 33 is joined to the trunk of the puppet by a shoulder pivot 35. Pivot 34 has one degree of liberty while pivot 35 has two degrees. The variables involved in the creation of an image of puppet 30 on a computer screen are schematically illustrated in FIG. 9, which shows a schematic representation of said forearm and upper arm, and additionally of a hand 36 and a shoulder 37. Forearm 32 and upper arm 33 are assumed to be parallel to the plane of the drawing, which can be taken as the BRP, and therefore, once the position of one of them is known, the other is determined by the angle (x which is the measure of the rotation about the pivot 34. The position of hand 36 with respect to forearm 32 and the position of upper arm 33 with respect to shoulder 37 are determined by two angles, since pivot 38 which connects hand to forearm and pivot 39 which connects upper arm to shoulder have two degrees of liberty. Two angles β and γ, one for each of said pivots, can be considered to be in a plane parallel to the BRP. Therefore, once the position of one of the rigid components 32, 33, 36 and 37 has been determined and its image can be shown on the computer screen, the positions of the other components and their images will be determined by the aforesaid angles. Measuring angles in a composite body, such as puppet 30, can be effected by locating two points on each of the adjacent components, thereby determining two lines that define the angle or angles.

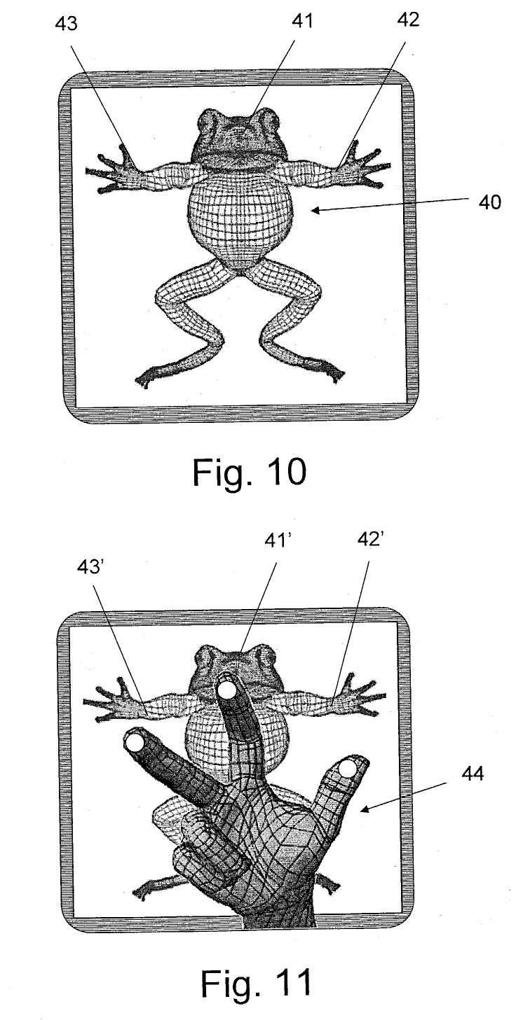

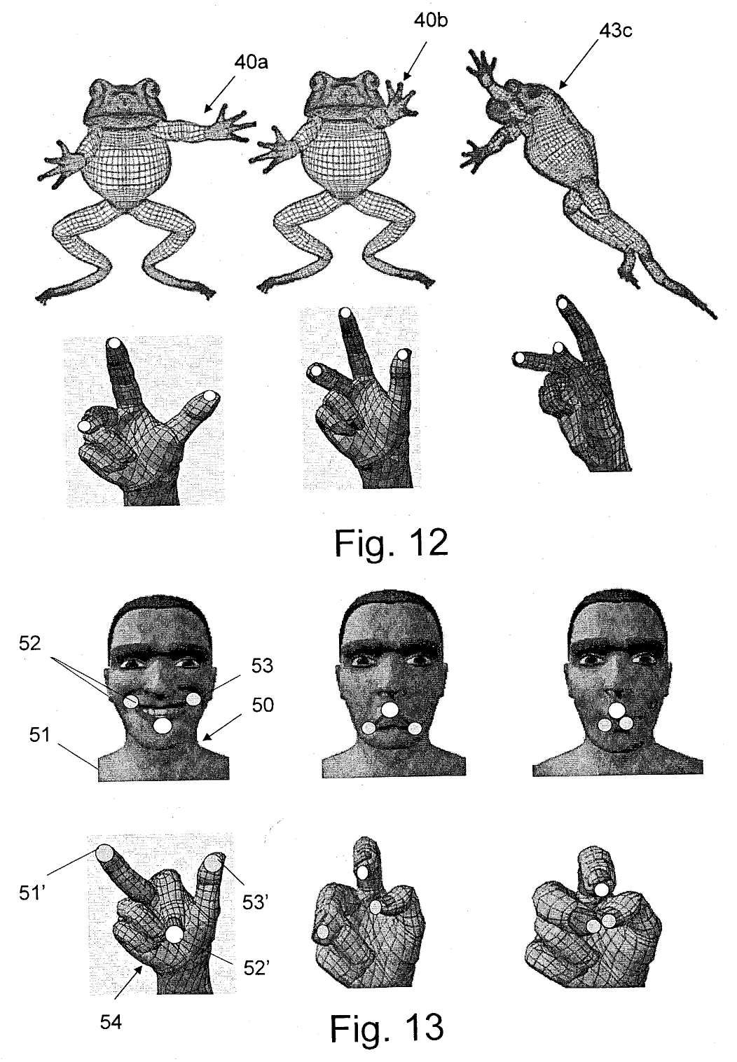

FIGS. 10 to 12 illustrate another embodiment of the invention, of particular interest for playing games. FIG. 10 schematically illustrates the virtual body 40 intended schematically to represent a frog or a puppet having the shape of a frog. Three points of the virtual frog, indicated as 41, 42 and 43, are associated by the software that has created it to three emitters 41′, 42′ and 43′, carried at the ends of three operator's fingers, the operator's hand being generally indicated at 44. A reference shape of the virtual frog 40 is associated to a given position of the said emitters. This is schematically illustrated in FIG. 11. When one of the emitters moves, the corresponding point on the virtual frog moves correspondingly and the entire virtual frog modifies its shape, according to instructions of the software that has created it. This is illustrated schematically in FIG. 12, which shows three configurations of the virtual frog, 40a, 40b and 40c, corresponding to three configurations 44a, 44b and 44c of the player's hand.

In a similar way, a virtual human body or face may be manipulated to change its expression. This is illustrated in FIG. 13, which shows a virtual head and upper part of a bust, generally indicated at 50, having points 51, 52 and 53 associated with emitters 51′, 52′ and 53′ carried by a player's hand 54. Three different configurations of said hand 54 are shown and each corresponds to a different expression of the virtual head.

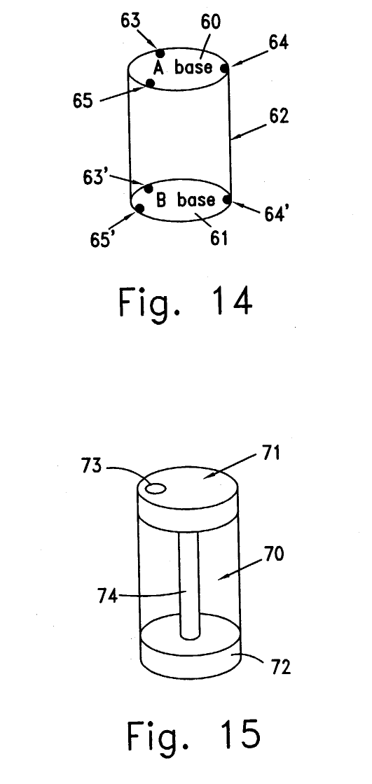

FIGS. 14 to 21 illustrate a method of manipulating and deforming images or virtual bodies and means for carrying said method into practice. For brevity's sake, reference will be made at times only to virtual bodies, but it should be understood that what is said always applies equally well to images of real bodies.

The position or coordinates of three radiation transmitters, or more precisely, of three transmitter antennae identify three points. The three points define a plane and an X and Y axis in said plane and an origin 0, which is their intersection, as has been explained hereinbefore. An axis perpendicular to the plane and passing through the origin 0 constitutes a Z axis. A spatial system of coordinates is thus defined by the three transmitter antennae. By SW, a point of a virtual body can be associated with the origin O of said system and a plane passing through said point can be associated with the X-Y plane of said system. Briefly, it can be said that a region of the virtual body is thus associated with said coordinate system. Said region (viz. said point and plane) will move if the coordinate system moves, viz. if the radiation transmitter antennae move.

FIG. 14 schematically illustrates a situation in which two terminal cross-sections 60 and 61 of a cylindrical body 62 contain each three transmitters 63-64-65 and 63′-64′-65′. Said terminal cross-sections will therefore define the X-Y planes of two coordinate systems and the axis of the body 62 will be parallel to the Z axis of said two systems. These two systems may be associated with regions of a virtual body, as hereinbefore explained, viz. their origins may be associated with two points of the virtual body and the X-Y planes may be associated with two planes of said virtual body. Therefore each set of three transmitters will define a spatial coordinate system.

If body 62—which will be called hereinafter “control body”, to distinguish it from the virtual body or the real body the image of which is shown on a computer screen—is deformable, particularly elastic, and is subject to such deformations that the relative position and/or orientations of cross-sections 60 and 61 will change, the configuration of the virtual body or image seen on the computer screen will change correspondingly. The simplest change will occur if the control body is stretched or compressed parallel to its axis: the virtual body or image will stretch or compress correspondingly. In this way, a virtual body or image can be controlled and its configuration can be changed by means of a control body.

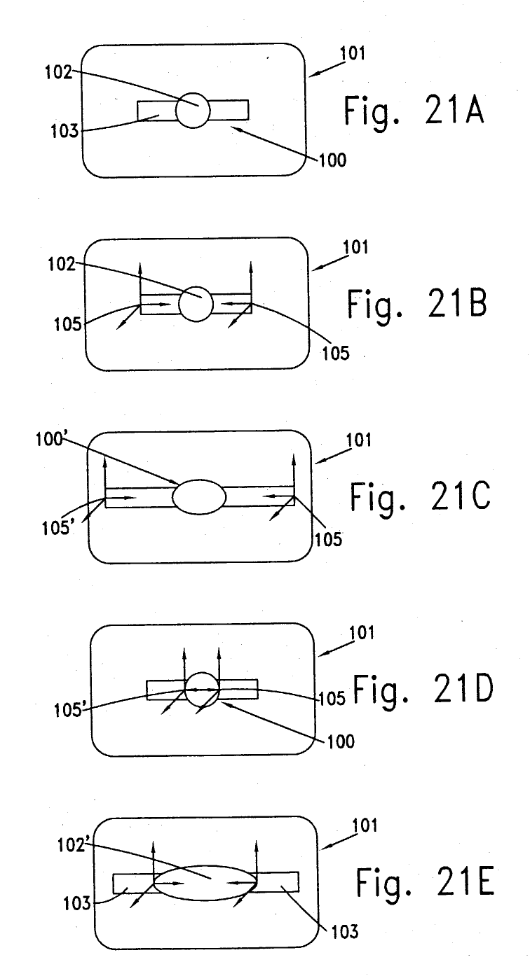

FIG. 15 shows how a control body may be created. An elastic cylinder 70 is provided. Two boxes 71 and 72 are attached to the two ends of body 70, and each will contain three antennae, not shown in the drawing. Each box 71 and 72 can be provided with a switch, only one of which—73—visible in the drawing, is the main switch. One of the boxes—box 72 in the drawing—additionally contains the generator that produces the radiation emitted by the antennae, and is connected to the antennae of box 72 directly and to the antennae of box 73 through conductors comprised in a cable or housed in a tube indicated in the drawing at 74. Said conductors also connect the main switch 73 to a switch contained in box 72. How such control body can control the deformation of virtual bodies or images seen on the computer screen, will be understood with reference to FIGS. 21A to 21E.

FIG. 21A shows a schematic example of a virtual body (or image) 100 seen on a screen 101. For purposes illustration, body 100 is shown as composed of a nucleus 102 and two wings 103. The control body comprises two sets of three transmitters, each defining a spatial coordinate system. Each of said spatial coordinate systems may be associated by SW to a computer coordinate system defined at the end of one of wings 103. Two such computer coordinate systems are shown in FIG. 21B at 105 and 105′. If now the control body is stretched, and the two sets of transmitters are displaced away from one another, the two spatial coordinate systems defined by them are displaced in the same way, and the SW will similarly displace coordinate systems 105 and 105′, As a results, the body 100 will be uniformly stretched, as seen at 100′ in FIG. 21C. However, each of said spatial coordinate systems may be associated by SW to a computer coordinate system defined at different positions of body 100, for instance at the ends of its nucleus 102, as shown in FIG. 21D. In that case, stretching the control body will result in a stretching of nucleus 102 only, as seen at 102′ in FIG. 21E, while wings 103 will remain unchanged.

While the foregoing explanation relates to the stretching of a schematic image, skilled persons will easily extend it to other deformations, including angular deformations such as bending or torsional ones, and other shapes of virtual bodies and images. In principle, there is a ratio between the extent of any deformations of a control body and extent of the corresponding deformations of the virtual body or image or parts on the computer screen. Said ratio can be fixed by SW and/or modified, as desired, in every specific case.

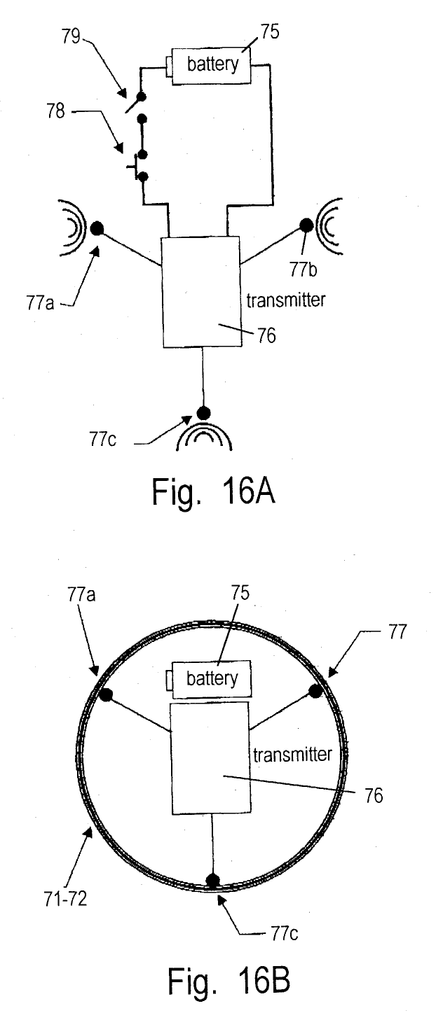

FIG. 16A schematically illustrates the structure of the circuits contained in the boxes 71 and 72, and FIG. 16B is a schematic cross-section of one of the boxes. Each box contains a battery 75 and a radiation generator 76, having three transmitter antennae 77a, 77b and 77c. 78 indicates one of the switches which activate the radiation generator when depressed. In this embodiment, another main switch, indicated at 79, is shown, which, when opened, will completely inactivate the circuit and therefore prevent undesired radiation emission.

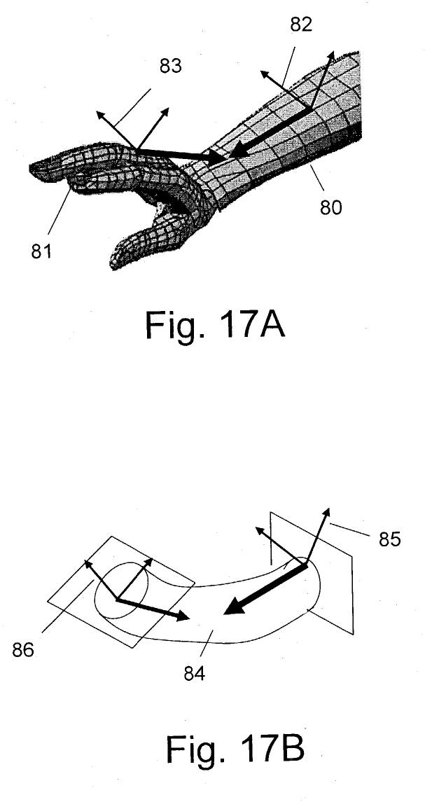

However, it is not necessary that an elastic control body be provided and operated by the players. A part of the body of a player, particularly his forearm and hand, can operate as control body, as schematically indicated in FIG. 17A, in which the forearm 80 and hand 81 of the player are shown and the position and orientation of two coordinate axis systems are schematically indicated at 82 and 83. These coordinate systems can be generated by two boxes, such as those illustrated in FIGS. 15A and 15B, attached to the player's forearm and hand. As a result, the player's forearm and hand can be schematically represented, insofar as the control of virtual bodies or images is concerned, by a control body 84 and coordinate systems 85 and 86, such as those illustrated in FIGS. 15A and 15B. FIG. 17B is such a schematic representation.

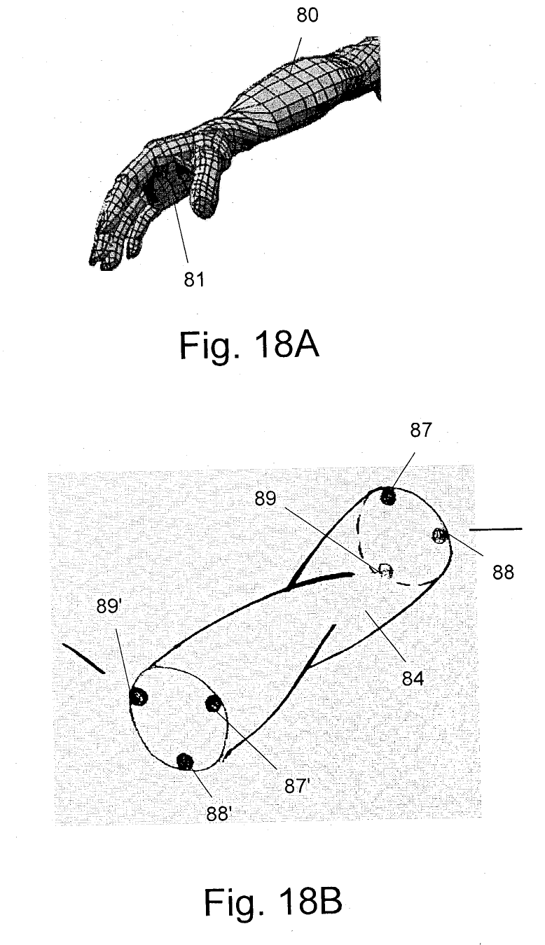

FIGS. 18A and 18B illustrate how twisting motions of the player's forearm 80 and hand 81 can produce a result similar to that obtained by twisting a control body 84, having at its ends transmitter antennae 87-88-89 and 87′-88′-89′

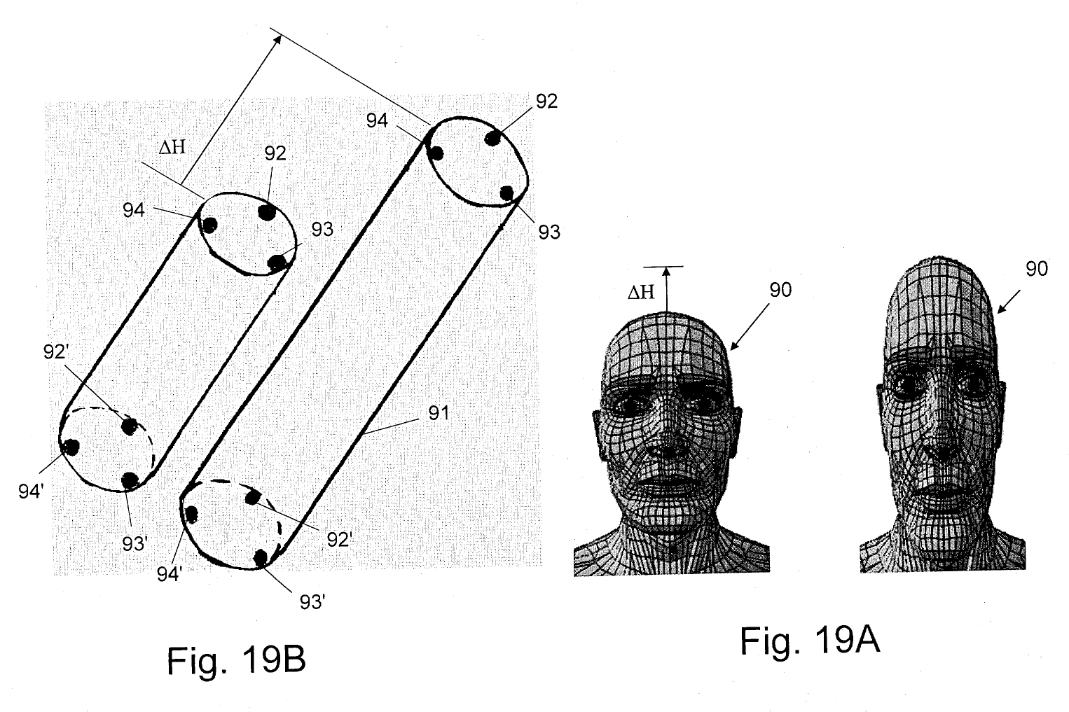

FIGS. 19A schematically illustrates the deformation of a virtual head 90, consisting in a stretching produced by stretching a control body 91, as illustrated in FIG. 19B, having at its ends transmitter antennae 92-93-94 and 92′-93′-94′. FIG. 19B shows two conditions of the control body, which is stretched from the one to the other by ΔH. Correspondingly, the head 90 is stretched by AH.

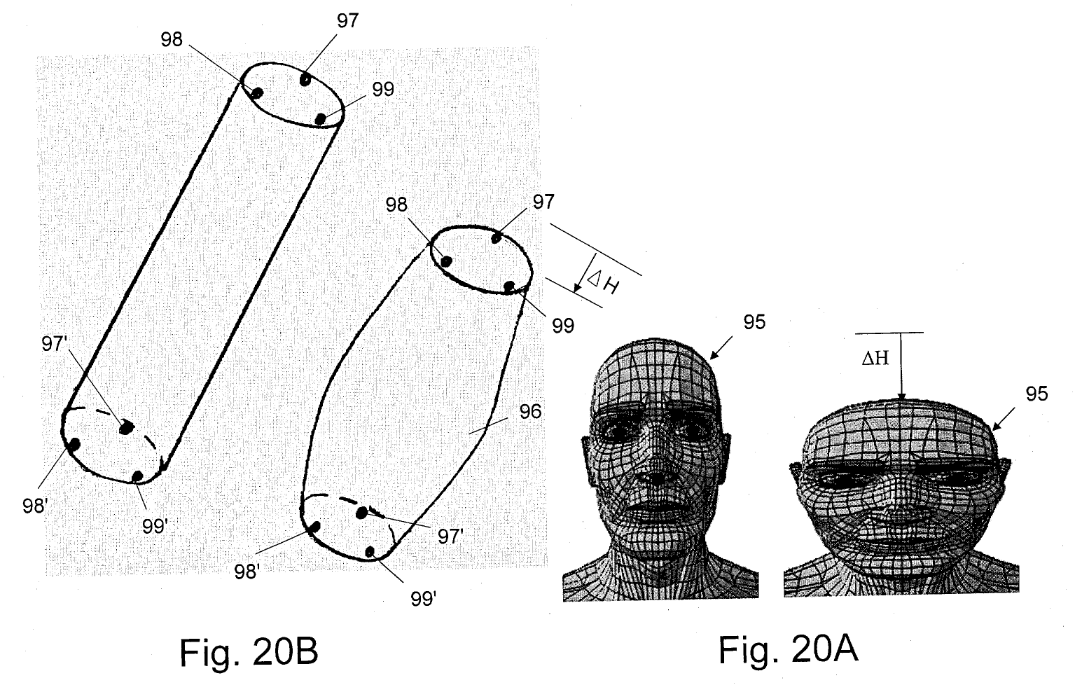

FIGS. 20A and 20B schematically illustrate in the same manner the deformation ΔH by compression of the virtual head 95 produced by compressing by ΔH a control body 96, having at its ends transmitter antennae 97-98-99 and 97′-98′-99′.

It will be understood that by the invention it is rendered possible to carry out computer games between two (or more) players located at different locations and even at great distanced, provided that their computers are connected and that they use the same software. Each player may manipulate a rigid or composite or deformable body, or each player may refer to a virtual body. The virtual body may be the same for more than one player or there may be a virtual body for each player. The interactions between images and/or virtual bodies are determined by software which person skilled in the art can easily formulate and is not basically different from the type of software that is at the basis of present computer games.

While embodiments of the invention have been described by way of illustration, it will be apparent that many modifications, variations and adaptations can be made therein by persons skilled in the art, without exceeding the scope of the claims.

1. Process for generating the image of a 3-dimensional rigid body on a computer screen by:
One) defining a system of 3-dimensional space coordinates in the space in which the body moves;
b) establishing a software, which defines the way in which the body appears when viewed at a given angle and distance to one of the coordinate planes;
c) determining the coordinates in said coordinates system of a number of points; and
d) transmitting to the computer said coordinates of said points of the rigid body and said software,
whereby the computer will create the image of the rigid body when in any specific position in space and viewed at any specific angle:

2. Process according to claim 1, wherein the points of the rigid body, the coordinates of which are determined, are in the number of three.

3. Process according to claim 1, wherein the rigid body has symmetries and the points thereof, the coordinates of which are determined, are less than three.

4. Process according to claim 1, wherein the rigid body has kinematic bonds and the points thereof, the coordinates of which are determined, are less than three.

5. Process according to claim 1, wherein step a) includes providing a number of radiation receivers, and attributing to them three coordinates X,Y,Z; and step c) includes providing a radiation transmitter at each/of the points of the rigid body the coordinates of which are to be determined, of determining in a known way the distance of each of said points from each of said receivers, and calculating from said distances the coordinates of each of said points in the coordinate system established in step a).

6. Process for generating the image on a computer screen of a 3-dimensional composite body, consisting of a plurality of rigid components connected by kinematic connections, wherein the relative position of components connected to one a other by one of said connections is determined by one or more kinematic parameters, which comprises the step of generating the image of a first component by the process of claim 1, and generating the images of the other components according to said kinematic parameters.

7. Process according to claim 6, wherein at least part of the kinematic connections are pivots and the kinematic parameters are angles of rotation about said pivots.

8. Process for representing the interaction between at least two real bodies, which comprises:
generating an image of a first real body;
generating an image of a second real body; and
modifying or integrating the software relative to said first body to cause the image thereof to react to the presence within a certain distance, and, optionally, in a certain direction, of the image of said second body.

9. Process for representing the interaction between a real body and a virtual body, which comprises:
providing a software which creates a virtual body;
generating an image of a real body; and
modifying or integrating said software to cause said virtual body to react to the presence of said image within a certain distance, and, optionally, in a certain direction.

10. Process according to claim 9, wherein the real body is deformable, further comprising modifying or integrating the software to cause the virtual body to react not only to the presence of the image of the real body, but also to its deformations.

11. Process for representing the interaction between real points, defined in space, and a virtual body or an image, which comprises:
I) defining a set of 3-dimensional space coordinates in the space in which the body moves, and storing in the computer's memory the definition of said set;
B) associating said real points to points of the virtual body or the image;
III) modifying the software which controls the virtual body or the image, insofar as necessary, to react to the motion of said real points;
IV) determining the coordinates of said real points with respect to said space coordinates set; and
V) transmitting to the computer said coordinates of said real points.

12. Process according to claim 11, wherein the real points are disjointed points, displaced independently of one another.

13. Process according to claim 12, wherein the real points are defined by radiation emitters carried by the fingers of an operator's hand or by other body parts of the operator.

14. Process for producing and controlling the deformation of virtual bodies or images, which comprises providing a deformable control body having at least two sets of radiation emitters, defining a corresponding number of systems of spatial coordinates by the positions of said emitters, associating each of said coordinate systems to one of two parts of the virtual body or image and deforming said control body to change the distance and/or relative orientation of said coordinate systems, whereby to change the distance and/or relative orientation of said two parts of the virtual body or image.

15. Process according to claim 14, wherein the control body is elastic.

16. Process according to claim 14, wherein each set of radiation emitters comprises a radiation generator and at least three emitter antennae connected to said generator.

17. Process according to claim 14, wherein is at least two sets of radiation emitters are connected one to each of two parts of a player's body, and said body part is used as control body.

18. Process according to claim 17, wherein the parts of a player's body are a forearm and a hand.

19. Process according to claim 14, wherein the control body is stretched, compressed and/or twisted, to produce corresponding deformations in the virtual body or image.

20. Process according to claim 14, comprising associating to each spatial coordinate system a computer coordinate system.

21. Process according to claim 20, wherein the at least two computer coordinate system are associated to spaced points of the virtual body or image.

22. Process according to claim 20, comprising defining and/or modifying a ratio between the linear and/or angular displacements of the spatial coordinate systems and the corresponding displacements of the computer coordinate systems.

23. Control body for controlling the deformation of virtual bodies or images on a computer screen, which comprises an elastic base and at least two sets of radiation emitters.

24. Control body according to claim 23, wherein each set of radiation emitters comprises at least three emitter antennae connected to a radiation generator.

25. Process for generating the image of a 3-dimensional rigid body is on a computer screen, substantially as described and illustrated.

26. Process for representing the interaction between at least two real bodies, substantially as described and illustrated.

27. Process for producing and controlling the deformation of virtual bodies or images, substantially as described and illustrated.

28. Process according to claim 18, wherein the control body is stretched, compressed and/or twisted, to produce corresponding deformations in the virtual body or image.
